(19) United States
(12) Patent Application Publication
(10) Pub. No.: US 2025/0155288 A1
(43) Pub. Date: May 15, 2025

(54) DYE RECIPE CALIBRATION APPARATUS AND METHOD

(71) Applicant: ELECTRONICS AND TELECOMMUNICATIONS RESEARCH INSTITUTE, Daejeon (KR)

(72) Inventors: Hyun Woo OH, Daejeon (KR); Ji Yong HWANG, Daejeon (KR)

(21) Appl. No.: 18/630,276

(22) Filed: Apr. 9, 2024

(30) Foreign Application Priority Data
Nov. 14, 2023 (KR) 10-2023-0157457

(51) Int. Cl. G01J 3/46; C09B 67/22

(52) U.S. Cl. CPC G01J 3/463; C09B 67/0033; G01J 2003/467

(57) ABSTRACT

Disclosed herein is a dye recipe calibration apparatus and method, wherein the dye recipe calibration apparatus includes a memory configured to store at least one instruction and a processor configured to execute the at least one instruction stored in the memory, and the processor calibrates a dye recipe on the basis of absorbance data for an electronic color value of a target color and absorbance data for each monochromatic dye constituting a mixed dye generated according to a dye recipe for the target color.

### CROSS-REFERENCE TO RELATED APPLICATION

This application claims priority to and the benefit of Korean Patent Application No. 10-2023-0157457, filed on Nov. 14, 2023, the disclosure of which is incorporated herein by reference in its entirety.

### BACKGROUND

### 1. Field of the Invention

The present invention relates to a dye recipe calibration apparatus and method.

### 2. Description of Related Art

In order to reproduce a color ordered by a buyer, on-site workers select three to six single color dyes used in the factory and calculate a dye mixing recipe through simulation. Dye mixing recipes are obtained through simulation on the basis of previously stored basic data. A B/T test is performed on the basis of several dye mixing recipes recommended through simulation. It is checked whether a color is reproduced in the B/T test, and when the color is reproduced through the B/T test, a dye mixing recipe is issued to the site through a prescription. However, since dyeing in the field is not performed at the laboratory level, scale-up occurs and color differences occur due to various factors. When a color difference occurs, the color difference is calibrated by comparing the color difference with the buyer order data through computer color matching (CCM) colorimetry to obtain information on a difference.

Meanwhile, conventionally, a dye mixing recipe is calculated using various methods (simulation using a CCM colorimetry system, simulation using an artificial intelligence (AI) model, and the like). However, the dye mixing recipe calculated through conventional methods still includes significant errors, and thus technology for calibrating a dye mixing recipe is required.

The related art of the present disclosure is disclosed in Korean Registered Patent No. 10-2035059 (Oct. 16, 2019).

### SUMMARY OF THE INVENTION

The present invention is directed to providing a dye recipe calibration apparatus and method that can compare absorbance data for an electronic color value of a target color according to a request of a customer with absorbance data for each of the monochromatic dyes constituting a mixed dye generated according to a dye recipe for the target color and calibrate the dye recipe on the basis of a result of the comparison.

According to an aspect of the present invention, there is provided a dye recipe calibration apparatus including a memory configured to store at least one instruction, and a processor configured to execute the at least one instruction stored in the memory, wherein the processor calibrates a dye recipe on the basis of absorbance data for an electronic color value of a target color and absorbance data for each monochromatic dye constituting a mixed dye generated according to a dye recipe for the target color.

The processor may generate absorbance data for the mixed dye on the basis of absorbance data for each of the monochromatic dyes, perform a process of detecting a maximum absorbance wavelength value, which is defined as a wavelength value having a largest absorbance, from the absorbance data for the electronic color value, the monochromatic dyes, and the mixed dye, determine a priority of each of the monochromatic dyes on the basis of maximum absorbance wavelength values for each of the monochromatic dyes and the electronic color value, and calibrate a dye recipe for a first priority monochromatic dye on the basis of maximum absorbance wavelength values for the electronic color value and the mixed dye.

The processor may determine that a monochromatic dye with a maximum absorbance wavelength value whose difference from the maximum absorbance wavelength value for the electronic color value is smallest is the first priority monochromatic dye.

When a difference between the maximum absorbance wavelength values for the electronic color value and the mixed dye is greater than or equal to a preset first reference value, the processor may change the first priority monochromatic dye to another monochromatic dye belonging to the same dye group.

The processor may detect a monochromatic dye with the smallest difference between the maximum absorbance wavelength values for the mixed dye, in which a monochromatic dye among monochromatic dyes belonging to the same dye group is the first priority monochromatic dye, and the electronic color value and sets the detected monochromatic dye as a new first priority monochromatic dye.

The processor may perform a process of detecting the maximum absorbance, which is defined as absorbance at a maximum absorbance wavelength value, from the absorbance data for the electronic color value and the mixed dye, and change a concentration of the first priority monochromatic dye to match the maximum absorbance for the electronic color value and the maximum absorbance for the mixed dye.

When the maximum absorbance for the electronic color value is greater than the maximum absorbance for the mixed dye, the processor may increase the concentration of the first priority monochromatic dye, and when the maximum absorbance for the electronic color value is less than the maximum absorbance for the mixed dye, the processor may decrease the concentration of the first priority monochromatic dye.

The processor may calibrate a dye recipe for a second priority monochromatic dye on the basis of the maximum absorbance wavelength value for the electronic color value and the maximum absorbance wavelength value for the mixed dye.

The processor may set a wavelength section with a preset size centered on the maximum absorbance wavelength value for the second priority monochromatic dye as a reference wavelength section, calculate a first calculated value defined as an absolute value of a difference between the absorbance of the electronic color value and the absorbance of the mixed dye integrated over the reference wavelength section, calculate a second calculated value defined as an absolute value of a difference between an absorbance of the electronic color value and an absorbance for the mixed dye integrated over the reference wavelength section, and calibrate the dye recipe for the second priority monochromatic dye on the basis of the first and second calculated values.

When a value obtained by subtracting the second calculated value from the first calculated value is greater than or equal to a preset second reference value, the processor may change the second priority monochromatic dye to another monochromatic dye belonging to the same dye group.

The processor may detect a monochromatic dye with the smallest value obtained by subtracting a second calculated value for a corresponding mixed dye from a first calculated value for the mixed dye in which a corresponding monochromatic dye among the monochromatic dyes belonging to the same dye group is the second priority monochromatic dye and set the detected monochromatic dye as a new second priority monochromatic dye.

After the dye recipe for the second priority monochromatic dye is calibrated, the processor may calculate a third calculated value defined as an absolute value of a difference between an absorbance of the electronic color value and an absorbance of the mixed dye integrated over a preset effective wavelength section and change a concentration of each of the monochromatic dyes so that the third calculated value is less than or equal to a preset third reference value.

According to another aspect of the present invention, there is provided a dye recipe calibration method including receiving absorbance data for an electronic color value of a target color and absorbance data for each monochromatic dye constituting a mixed dye generated according to a dye recipe for the target color, and calibrating the dye recipe on the basis of absorbance data for the electronic color value and absorbance data for each of the monochromatic dyes.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a dye recipe calibration apparatus according to an embodiment of the present invention;

FIG. 2 is a flowchart illustrating a dye recipe calibration method according to an embodiment of the present invention;

FIG. 3 is an exemplary diagram for describing the dye recipe calibration method according to the embodiment of the present invention;

FIG. 4 is a flowchart illustrating a dye recipe calibration method for a first priority monochromatic dye according to an embodiment of the present invention;

FIGS. 5 and 6A-6B are exemplary diagrams for describing the dye recipe calibration method for the first priority monochromatic dye according to the embodiment of the present invention;

FIG. 7 is a flowchart illustrating a dye recipe calibration method for a second priority monochromatic dye according to an embodiment of the present invention;

FIG. 8 is an exemplary diagram for describing the dye recipe calibration method for the second priority monochromatic dye according to the embodiment of the present invention;

FIG. 9 is a flowchart illustrating a dye recipe calibration method for each priority monochromatic dye according to an embodiment of the present invention; and

FIG. 10 is an exemplary diagram for describing the dye recipe calibration method for each priority monochromatic dye according to the embodiment of the present invention.

### DETAILED DESCRIPTION OF EXEMPLARY EMBODIMENTS

Hereinafter, a dye recipe calibration apparatus and method according to embodiments of the present invention will be described in detail with reference to the accompanying drawings. In the following description, the thicknesses of lines and sizes of components shown in the drawings may be exaggerated for clarity and convenience of explanation. In addition, terms described below are defined in consideration of the functions of the present invention, and these terms may be varied according to the intent or custom of a user or an operator. Therefore, these terms should be defined on the basis of the contents throughout the present specification.

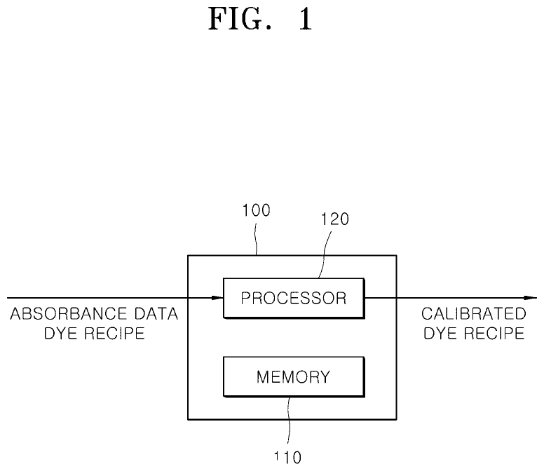

FIG. 1 is a block diagram illustrating a dye recipe calibration apparatus according to an embodiment of the present invention.

Referring to FIG. 1, a dye recipe calibration apparatus 100 according to the embodiment of the present invention may include a memory 110 and a processor 120. The dye recipe calibration apparatus 100 according to the embodiment of the present invention may further include various components in addition to the components shown in FIG. 1, or some of the components may be omitted. For example, the dye recipe calibration apparatus 100 according to the embodiment of the present invention may further include an input/output interface for receiving arbitrary data or outputting data calculated by the processor 120, and a user interface for interacting with a user.

At least one instruction executed by the processor 120 may be stored in the memory 110. The memory 110 may be implemented as a volatile storage medium and/or a non-volatile storage medium, for example, as a read only memory (ROM) and/or a random access memory (RAM).

The memory 110 may store various types of information required during the operation of the processor 120. For example, the memory 110 may store a knowledge base related to a task to be performed. The memory 110 may store various types of information calculated during the operation of the processor 120.

The processor 120 may be implemented as a central processing unit (CPU) or a system on chip (SoC), may run an operating system or an application to control a plurality of hardware or software components connected to the processor 120, and may perform various data processing and calculating operations. The processor 120 may execute at least one instruction stored in the memory 110 and store data of the execution result in the memory 110.

The processor 120 may calibrate a dye recipe on the basis of absorbance data for an electronic color value of a target color and absorbance data for each of the monochromatic dyes constituting a mixed dye generated according to a dye recipe for the target color. Here, the target color is a color requested by a customer and may be a color desired to be realized through a dyeing process. The electronic color value is a computer color matching (CCM) colorimetry value for the target color and may be a color value determined according to a QuickTime Extension (QTX) file. The absorbance data may be data which contains relationship information on absorbance (or absorption rate) according to a wavelength at a specific concentration.

Hereinafter, on the basis of the above-described context, the dye calibration method according to the embodiment of the present invention will be described focusing on the operation of the processor 120. Some of the processes described below may be performed in an order different from the order described below or may be omitted.

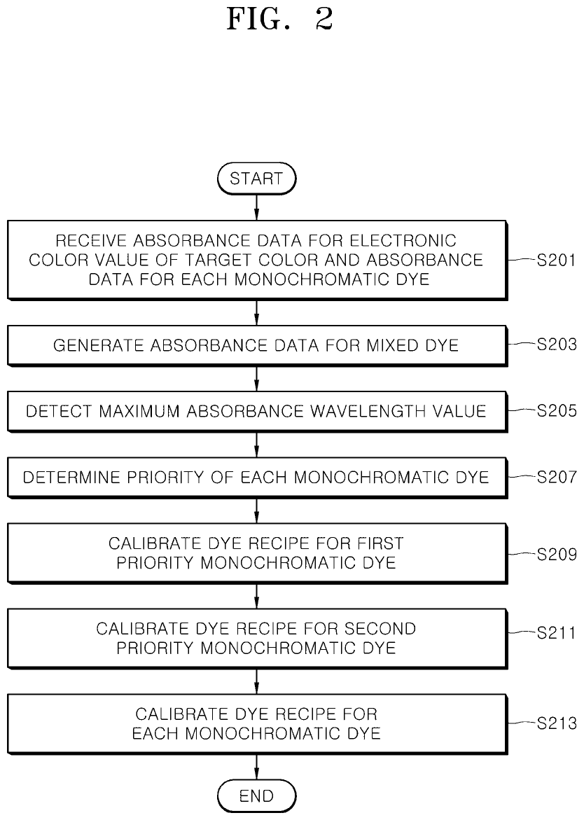

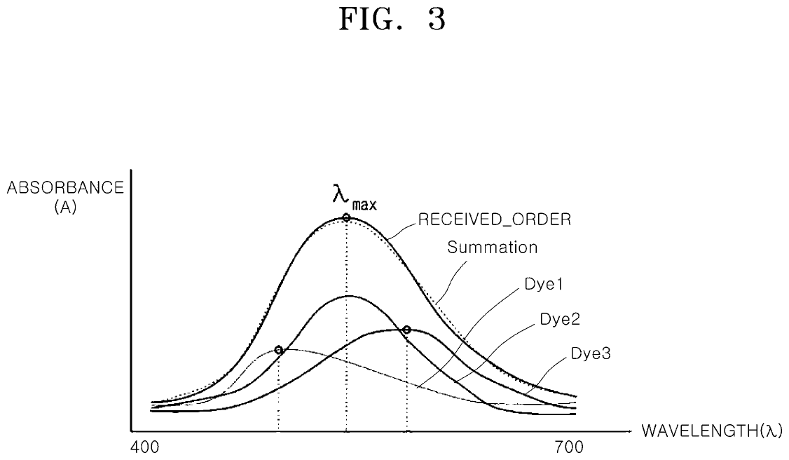

FIG. 2 is a flowchart illustrating a dye recipe calibration method according to an embodiment of the present invention, and FIG. 3 is an exemplary diagram for describing the dye recipe calibration method according to the embodiment of the present invention.

Referring to FIG. 2, the processor 120 may first receive absorbance data for an electronic color value of a target color and absorbance data for each of the monochromatic dyes constituting a mixed dye generated according to a dye recipe for the target color (S201). In this case, the processor 120 may receive not only absorbance data for a monochromatic dye with a concentration according to the dye recipe, but also absorbance data for a monochromatic dye with a random concentration, that is, absorbance data for a concentration of each monochromatic dye. In addition, the processor 120 may receive absorbance data for each monochromatic dye belonging to the same dye group of the monochromatic dye included in the mixed dye created according to the dye recipe. In addition, the processor 120 may receive data on the dye recipe.

The processor 120 may receive required absorbance data from an external device capable of calculating absorbance data or an external device which stores absorbance data. Meanwhile, hereinafter, for convenience of description, the “electronic color value of the target color” will be described as the “electronic color value,” the “mixed dye generated according to the dye recipe for the target color” will be described as the “mixed dye,” and the “monochromatic dye constituting the mixed dye produced according to the dye recipe for the target color” will be described as the “monochromatic dye.” In addition, unless otherwise specified below, the “absorbance data for the monochromatic dye” may be understood as “absorbance data for a monochromatic dye with a concentration determined according to the dye recipe.”

Subsequently, the processor 120 may generate absorbance data for the mixed dye on the basis of the absorbance data for each monochromatic dye (S203). In this case, the processor 120 may generate the absorbance data for the mixed dye by summing the absorbance data for the monochromatic dyes.

For example, as shown in FIG. 3, assuming that the mixed dye Summation includes first to third monochromatic dyes Dye1, Dye2, and Dye3, absorbance for the mixed dye Summation at wavelength a may be calculated as the sum of the absorbance for the first monochromatic dye Dye1 at wavelength a, the absorbance for the second monochromatic dye Dye2 at wavelength a, and the absorbance for the third monochromatic dye Dye3 at wavelength a.

Subsequently, the processor 120 may perform a process of detecting a maximum absorbance wavelength value from the absorbance data for the electronic color value, the monochromatic dyes, and the mixed dye (S205). Here, the maximum absorbance wavelength value may be defined as a wavelength value with the largest absorbance.

For example, as shown in FIG. 3, assuming that absorbance for an electronic color value Received_Order increases in the wavelength range of 400 nm to 550 nm and decreases in the wavelength range of 550 nm to 700 nm, a maximum absorbance wavelength value for the electronic color value may be 550 nm.

Subsequently, the processor 120 may determine a priority of each of the monochromatic dyes on the basis of maximum absorbance wavelength values for each monochromatic dye and the maximum absorbance wavelength value for the electronic color value (S207). The processor 120 may determine that a monochromatic dye with a maximum absorbance wavelength value whose difference (distance) from the maximum absorbance wavelength value for the electronic color value is smallest is a first priority monochromatic dye. The processor 120 may determine a monochromatic dye with a maximum absorbance wavelength value whose difference from the maximum absorbance wavelength value for the electronic color value is next to that of the first priority monochromatic dye as a second priority monochromatic dye.

For example, as shown in FIG. 3, when monochromatic dyes are arranged in the order of the smallest difference between the electronic color value and the maximum absorbance wavelength value, assuming the order is the second monochromatic dye Dye2, the third monochromatic dye Dye3, and the first monochromatic dye Dye1, the processor 120 determines that the second monochromatic dye is the first priority monochromatic dye, the third monochromatic dye is the second priority monochromatic dye, and the monochromatic dye is the third priority monochromatic dye.

Subsequently, the processor 120 may calibrate the dye recipe for the first priority monochromatic dye on the basis of the maximum absorbance wavelength value for the electronic color value and the maximum absorbance wavelength value for the mixed dye (S209). A detailed method of calibrating the dye recipe for the first priority monochromatic dye will be described below.

Subsequently, the processor 120 may calibrate the dye recipe for the second priority monochromatic dye on the basis of the maximum absorbance wavelength value for the electronic color value and the maximum absorbance wavelength value for the mixed dye (S211). A detailed method of calibrating the dye recipe for the second priority monochromatic dye will be described below.

Subsequently, the processor 120 may calibrate the dye recipe for each monochromatic dye on the basis of the maximum absorbance wavelength value for the electronic color value and the maximum absorbance wavelength value for the mixed dye (S213). A detailed method of calibrating the dye recipe for each monochromatic dye will be described below.

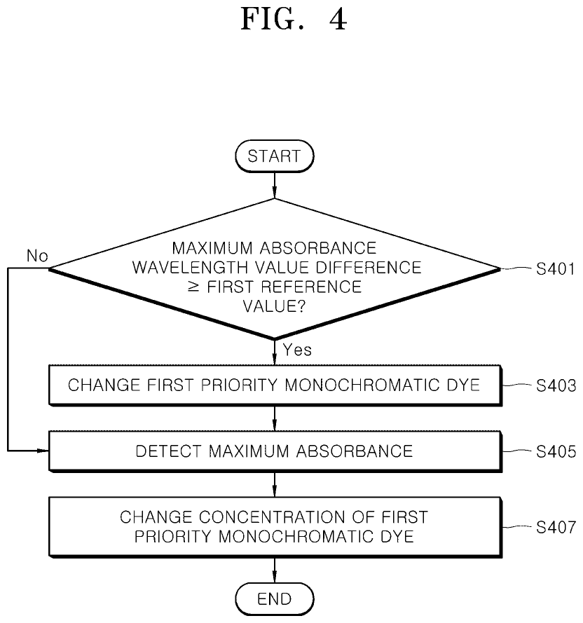

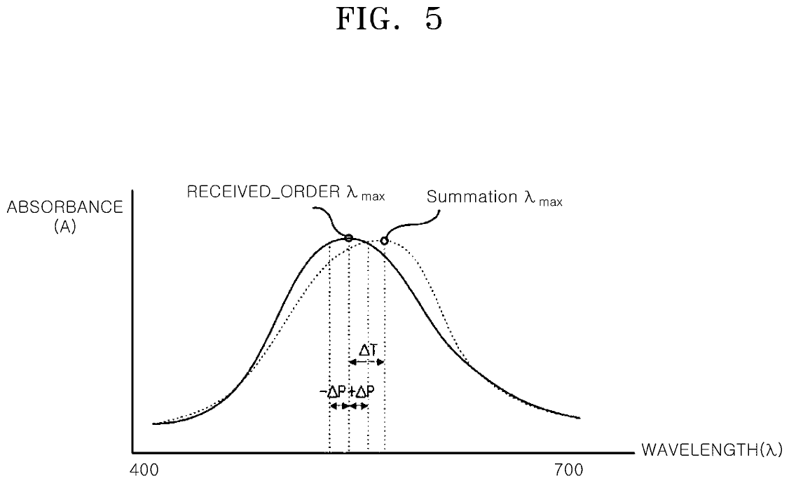

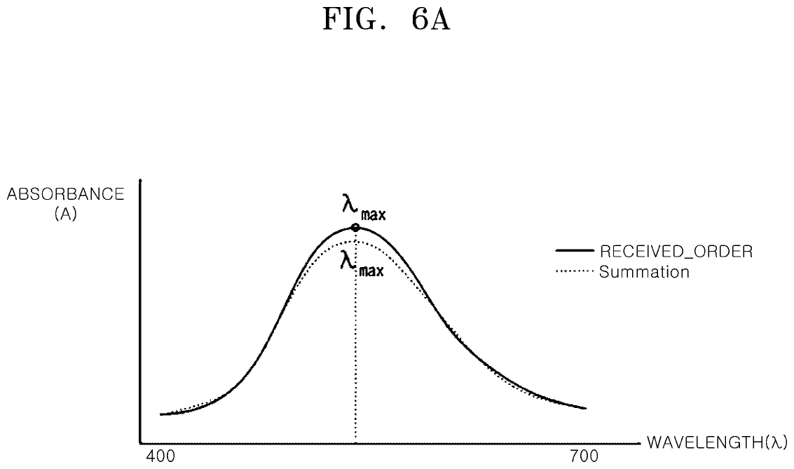

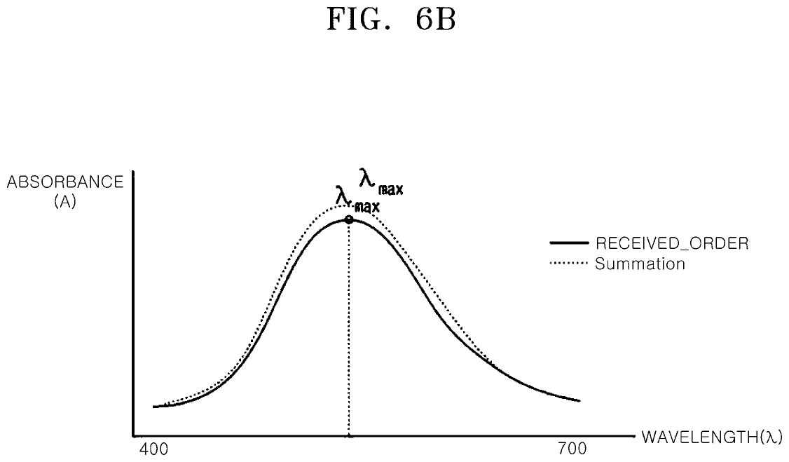

FIG. 4 is a flowchart illustrating a dye recipe calibration method for a first priority monochromatic dye according to an embodiment of the present invention, and FIGS. 5 and 6 are exemplary diagrams for describing the dye recipe calibration method for the first priority monochromatic dye according to the embodiment of the present invention.

Referring to FIG. 4, the processor 120 may first determine whether a difference between the maximum absorbance wavelength value for the electronic color value and the maximum absorbance wavelength value for the mixed dye is greater than or equal to a first preset reference value (S401).

When the difference between the maximum absorbance wavelength value for the electronic color value and the maximum absorbance wavelength value for the mixed dye is greater than or equal to the first reference value, the processor 120 may change the first priority monochromatic dye to another monochromatic dye belonging to the same dye group. (S403). When the difference between the maximum absorbance wavelength value for the electronic color value and the maximum absorbance wavelength value for the mixed dye is greater than or equal to the first reference value, it is difficult to adjust the overall difference in absorbance between the electronic color value and mixed dye below an allowable value just by adjusting the concentration of the first priority monochromatic dye. Therefore, in this case of the present embodiment, the dye recipe may be calibrated by changing the first priority monochromatic dye, which is a dye having the greatest influence on the absorbance of the mixed dye, to another monochromatic dye. When the first priority monochromatic dye is changed to another monochromatic dye, the processor 120 may change the first priority monochromatic dye to another monochromatic dye with the same concentration as the existing first priority monochromatic dye.

For example, as shown in FIG. 5, assuming that the second monochromatic dye Dye2 is the first priority monochromatic dye, and a difference ΔT between the maximum absorbance wavelength value (Received_Order λₘₐₓ) for the electronic color value and the maximum absorbance wavelength value (Summation λₘₐₓ) for the mixed dye is greater than or equal to the first reference value ΔP, the processor 120 may change the second monochromatic dye Dye2, which is the first priority monochromatic dye, to another monochromatic dye belonging to the same dye group. The monochromatic dye may be classified into a series (group) on the basis of color, and information on which monochromatic dye belongs to which series may be preset.

In this case, the processor 120 may detect a monochromatic dye with the smallest difference between the maximum absorbance wavelength values for the mixed dye, in which a monochromatic dye among monochromatic dyes belonging to the same dye group is the first priority monochromatic dye, and the electronic color value and set the detected monochromatic dye as a new first priority monochromatic dye. The processor 120 may detect the new monochromatic dye replacing the existing first priority monochromatic dye by performing a process of calculating a difference between the maximum absorbance wavelength value for the mixed dye, which includes the corresponding monochromatic dye instead of the existing first priority monochromatic dye, and the maximum absorbance wavelength value for the electronic color value on each monochromatic dye belonging to the same dye group of the existing first priority monochromatic dye and comparing the calculated differences. In this case, the processor 120 may perform the above-described process under the same concentration condition as the concentration of the existing first priority monochromatic dye.

When the difference between the maximum absorbance wavelength value for the electronic color value and the maximum absorbance wavelength value for the mixed dye is less than the first reference value, or after the first priority monochromatic dye is changed to another monochromatic dye, the processor 120 may perform a process of detecting the maximum absorbance from the absorbance data for the electronic color value and the mixed dye (S405). Here, the maximum absorbance may be defined as absorbance at the maximum absorbance wavelength value.

Subsequently, the processor 120 may change the concentration of the first priority monochromatic dye to match the maximum absorbance for the electronic color value and the maximum absorbance for the mixed dye (S407). In this case, when the maximum absorbance for the electronic color value is greater than the maximum absorbance for the mixed dye, the processor 120 may increase the concentration of the first priority monochromatic dye, and when the maximum absorbance for the electronic color value is less than the maximum absorbance for the mixed dye, the processor 120 may decrease the concentration of the first priority monochromatic dye.

For example, as shown in FIG. 6A, assuming that the second monochromatic dye, which is the first priority monochromatic dye, is changed to a new monochromatic dye and the maximum absorbance for the electronic color value Received_Order is greater than the maximum absorbance for the mixed dye Summation, the processor 120 may increase the concentration of the second monochromatic dye, which is the first priority monochromatic dye, to match the maximum absorbance for the electronic color value Received_Order and the maximum absorbance for the mixed dye Summation.

In addition, as shown in FIG. 6B, assuming that the second monochromatic dye, which is the first priority monochromatic dye, is changed to a new monochromatic dye and the maximum absorbance for the electronic color value Received_Order is smaller than the maximum absorbance for the mixed dye Summation, the processor 120 may decrease the concentration of the second monochromatic dye, which is the first priority monochromatic dye, to match the maximum absorbance for the electronic color value Received_Order and the maximum absorbance for the mixed dye Summation.

The processor 120 may match the maximum absorbance for the electronic color value and the maximum absorbance for the mixed dye by repeatedly performing the process of changing the concentration of the first priority monochromatic dye, the process of calculating the maximum absorbance for the mixed dye including the first priority monochromatic dye with the changed concentration, and the process of comparing the maximum absorbance for the new mixed dye with the maximum absorbance for the electronic color value.

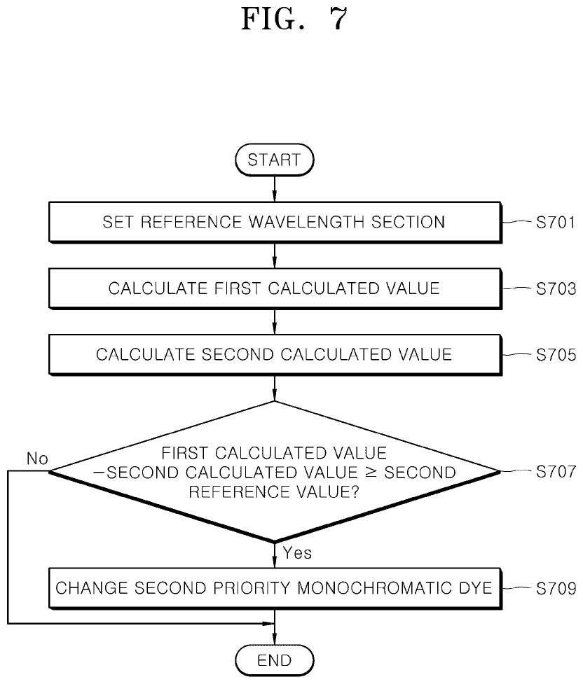

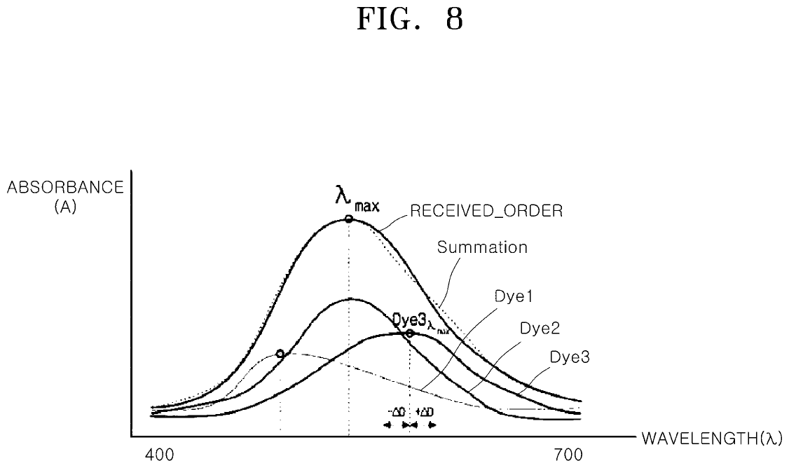

FIG. 7 is a flowchart illustrating a dye recipe calibration method for a second priority monochromatic dye according to an embodiment of the present invention, and FIG. 8 is an exemplary diagram for describing the dye recipe calibration method for the second priority monochromatic dye according to the embodiment of the present invention.

Referring to FIG. 7, the processor 120 may first set a wavelength section with a preset size centered on the maximum absorbance wavelength value for the second priority monochromatic dye as a reference wavelength section (S701). For example, assuming that the maximum absorbance wavelength for the second priority monochromatic dye is 500 nm and the set size is 100 nm, the processor 120 may set a wavelength range of 450 nm to 550 nm as the reference wavelength range.

Subsequently, the processor 120 may calculate a first calculated value, which is defined as an absolute value of a difference between the absorbance for the electronic color value and the absorbance for the mixed dye integrated over the reference wavelength section, from the absorbance data for the electronic color value and the mixed dye (S703). For example, assuming that the absorbance for the electronic color value is A, the absorbance for the mixed dye is B, a starting point of the reference wavelength section is λₛ, and an end point of the reference wavelength section is λₑ, a first calculated value Abs (A) may be defined by the following Equation 1.

$$Abs ( B ) = \sum \vert A - B \vert from {λ}_{s} to {λ}_{e} \qquad [ Equation 1 ]$$

Subsequently, the processor 120 may calculate a second calculated value, which is defined as an absolute value of a difference between the absorbance for the electronic color value and the absorbance for the mixed dye integrated over the reference wavelength section, from the absorbance data for the electronic color value and the mixed dye (S705). For example, assuming that the absorbance for the electronic color value is A, the absorbance for the mixed dye is B, a starting point of the reference wavelength section is λₛ, and an end point of the reference wavelength section is λₑ, a second calculated value Abs (B) may be defined by the following Equation 2.

$$Abs ( A ) = \sum \vert A - B \vert from {λ}_{s} to {λ}_{e} \qquad [ Equation 2 ]$$

Subsequently, the processor 120 may determine whether a value obtained by subtracting the second calculated value from the first calculated value is greater than or equal to a preset second reference value (S707).

When the value obtained by subtracting the second calculated value from the first calculated value is less than the second reference value, the processor 120 may terminate the corresponding process. On the other hand, when the value obtained by subtracting the second calculated value from the first calculated value is greater than or equal to the second reference value, the processor 120 may change the second priority monochromatic dye to another monochromatic dye belonging to the same dye group (S709). When the value obtained by subtracting the second calculated value from the first calculated value is greater than or equal to the second reference value, it is difficult to set the overall difference in absorbance between the electronic color value and the mixed dye below an allowable value just by adjusting the concentration of the second priority monochromatic dye. Therefore, in this case, in the present embodiment, the dye recipe may be calibrated by performing calibration to change the second priority monochromatic dye to another monochromatic dye.

For example, as shown in FIG. 8, assuming that the third monochromatic dye Dye3 is the second priority monochromatic dye and the value obtained by subtracting the second calculated value from the first calculated value is greater than or equal to the second reference value, the processor 120 may change the third monochromatic dye Dye3, which is the second priority monochromatic dye, to another monochromatic dye belonging to the same dye group.

In this case, the processor 120 may detect a monochromatic dye with the smallest value obtained by subtracting a second calculated value for a corresponding mixed dye from a first calculated value calculated for the mixed dye in which a corresponding monochromatic dye among the monochromatic dyes belonging to the same dye group is the second priority monochromatic dye and set the detected monochromatic dye as a new second priority monochromatic dye. The processor 120 may detect the new monochromatic dye replacing the existing second priority monochromatic dye by performing a process of calculating a value, which is obtained by subtracting the second calculated value for the corresponding mixed dye from the first calculated value for the mixed dye including the corresponding monochromatic dye instead of the existing second priority monochromatic dye, on each monochromatic dye belonging to the same dye group of the existing second priority monochromatic dye and comparing the calculated results. In this case, the processor 120 may perform the above-described process under the same concentration conditions as the concentration of the existing first priority monochromatic dye.

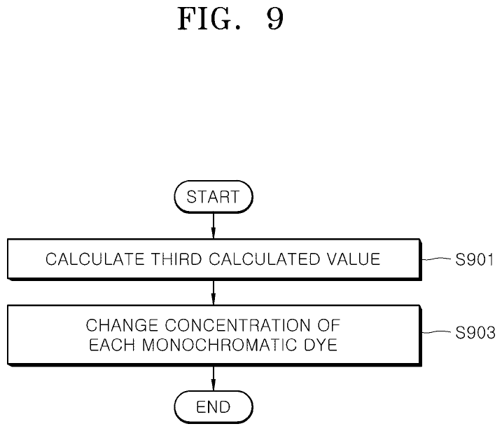

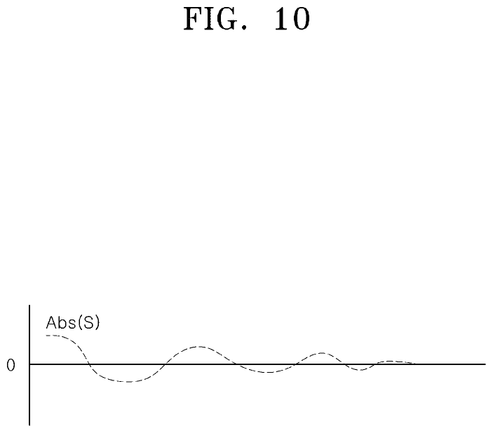

FIG. 9 is a flowchart illustrating a dye recipe calibration method for each priority monochromatic dye according to an embodiment of the present invention, and FIG. 10 is an exemplary diagram for describing the dye recipe calibration method for each priority monochromatic dye according to the embodiment of the present invention.

Referring to FIG. 9, the processor 120 may first calculate a third calculated value, which is defined as an absolute value of a difference between the absorbance for the electronic color value and the absorbance for the mixed dye integrated over a preset effective wavelength section, from the absorbance data for the electronic color value and the mixed dye (S901). The effective wavelength section may be set in advance through an experiment or simulation. For example, the range of 400 nm to 700 nm may correspond to the effective wavelength section. Assuming that the absorbance for the electronic color value is A, the absorbance for the mixed dye is B, and the effective wavelength section ranges from 400 nm to 700 nm, a third calculated value Abs(S) may be defined by the following Equation 3. The third calculated value Abs(S) may be the degree of offset between the absorbance for the mixed dye and the absorbance for the electronic color value.

$$Abs ( S ) = \sum \vert A - B \vert from 400 nm to 700 nm$$

Subsequently, the processor 120 may change the concentration of each monochromatic dye so that the third calculated value is less than or equal to a third preset reference value (S903). In this case, the processor 120 may sequentially change the concentration of each monochromatic dye, starting from the first priority monochromatic dye. The processor 120 may repeatedly perform the process of FIG. 9, and thus, the processor 120 may gradually reduce the third calculated value Abs(S) as shown in FIG. 10.

The processor 120 may cause a third reference value for the mixed dye to be less than or equal to the third reference value by repeatedly performing the process of changing the concentration of each monochromatic dye, the process of calculating the third calculated value for the mixed dye including the monochromatic dyes whose concentrations are changed.

As described above, the dye recipe calibration apparatus and method may compare absorbance data for an electronic color value of a target color according to a request of a customer with absorbance data for each of the monochromatic dyes constituting a mixed dye generated according to a dye recipe for the target color and calibrate the dye recipe on the basis of a result of the comparison.

Implementations described herein may also be implemented by, for example, a method or process, an apparatus, a software program, a data stream, or a signal. Even when only discussed in the context of a single form of implementation (e.g., discussed only as a method), the implementation of discussed features may also be implemented in other forms (e.g., an apparatus or program). The apparatus may be implemented in suitable hardware, software, and firmware. The method may be implemented in an apparatus such as a processor, which is generally referred to as a processing device including, for example, a computer, a microprocessor, an integrated circuit, or a programmable logic device. The processor also includes communication devices such as computers, cellular phones, portable/personal digital assistants (“PDAs”), and other devices that facilitate information communication between end-users.

According to an aspect of the present invention, absorbance data for an electronic color value of a target color according to a request of a customer is compared with absorbance data for each of the monochromatic dyes constituting a mixed dye generated according to a dye recipe for the target color so that the dye recipe can be calibrated on the basis of a result of the comparison.

Meanwhile, it should be noted that effects of the present invention are not limited to the above described effect, and other effects of the present invention that are not described above can be clearly understood by those skilled in the art from the above description.

While the present invention has been described with reference to embodiments shown in the accompanying drawings, these embodiments are merely illustrative and it should be understood that various modifications and equivalent other embodiments can be derived by those skilled in the art on the basis of the embodiments. Therefore, the true technical scope of the present invention should be defined by the appended claims.

What is claimed is:

1. A dye recipe calibration apparatus comprising:
a memory configured to store at least one instruction; and
a processor configured to execute the at least one instruction stored in the memory,
wherein the processor calibrates a dye recipe on the basis of absorbance data for an electronic color value of a target color and absorbance data for each monochromatic dye constituting a mixed dye generated according to the dye recipe for the target color.

2. The dye recipe calibration apparatus of claim 1, wherein the processor generates absorbance data for the mixed dye on the basis of absorbance data for each of the monochromatic dyes, performs a process of detecting a maximum absorbance wavelength value, which is defined as a wavelength value having a largest absorbance, from the absorbance data for the electronic color value, the monochromatic dyes, and the mixed dye, determines a priority of each of the monochromatic dyes on the basis of maximum absorbance wavelength values for each of the monochromatic dyes and the electronic color value, and calibrates a dye recipe for a first priority monochromatic dye on the basis of maximum absorbance wavelength values for the electronic color value and the mixed dye.

3. The dye recipe calibration apparatus of claim 2, wherein the processor determines that a monochromatic dye with a maximum absorbance wavelength value whose difference from the maximum absorbance wavelength value for the electronic color value is smallest is the first priority monochromatic dye.

4. The dye recipe calibration apparatus of claim 2, wherein, when a difference between maximum absorbances for the electronic color value and the mixed dye is greater than or equal to a preset first reference value, the processor changes the first priority monochromatic dye to another monochromatic dye belonging to the same dye group.

5. The dye recipe calibration apparatus of claim 4, wherein the processor detects a monochromatic dye with the smallest difference between the maximum absorbance wavelength values for the mixed dye, in which a monochromatic dye among monochromatic dyes belonging to the same dye group is the first priority monochromatic dye, and the electronic color value and sets the detected monochromatic dye as a new first priority monochromatic dye.

6. The dye recipe calibration apparatus of claim 2, wherein the processor performs a process of detecting the maximum absorbance, which is defined as absorbance at a maximum absorbance wavelength value, from the absorbance data for the electronic color value and the mixed dye and changes a concentration of the first priority monochromatic dye to match the maximum absorbance for the electronic color value and the maximum absorbance for the mixed dye.

7. The dye recipe calibration apparatus of claim 6, wherein, when the maximum absorbance for the electronic color value is greater than the maximum absorbance for the mixed dye, the processor increases the concentration of the first priority monochromatic dye, and when the maximum absorbance for the electronic color value is less than the maximum absorbance for the mixed dye, the processor decreases the concentration of the first priority monochromatic dye.

8. The dye recipe calibration apparatus of claim 2, wherein the processor calibrates a dye recipe for a second priority monochromatic dye on the basis of the maximum absorbance wavelength values for the electronic color value and the maximum absorbance wavelength value for the mixed dye.

9. The dye recipe calibration apparatus of claim 8, wherein the processor sets a wavelength section with a preset size centered on the maximum absorbance wavelength value for the second priority monochromatic dye as a reference wavelength section, calculates a first calculated value defined as an absolute value of a difference between an absorbance of the electronic color value and an absorbance of the mixed dye integrated over the reference wavelength section, calculates a second calculated value defined as an absolute value of a difference between the electronic color value and the absorbance for the mixed dye integrated over the reference wavelength section, and calibrates the dye recipe for the second priority monochromatic dye on the basis of the first and second calculated values.

10. The dye recipe calibration apparatus of claim 9, wherein, when a value obtained by subtracting the second calculated value from the first calculated value is greater than or equal to a preset second reference value, the processor changes the second priority monochromatic dye to another monochromatic dye belonging to the same dye group.

11. The dye recipe calibration apparatus of claim 10, wherein the processor detects a monochromatic dye with the smallest value obtained by subtracting a second calculated value for a corresponding mixed dye from a first calculated value for the mixed dye in which a corresponding monochromatic dye among the monochromatic dyes belonging to the same dye group is the second priority monochromatic dye and sets the detected monochromatic dye as a new second priority monochromatic dye.

12. The dye recipe calibration apparatus of claim 8, wherein, after the dye recipe for the second priority monochromatic dye is calibrated, the processor calculates a third calculated value defined as an absolute value of a difference between an absorbance of the electronic color value and an absorbance of the mixed dye integrated over a preset effective wavelength section and changes a concentration of each of the monochromatic dyes so that the third calculated value is less than or equal to a preset third reference value.

13. A dye recipe calibration method performed by a computing device including a processor, the dye recipe calibration method comprising:
receiving absorbance data for an electronic color value of a target color and absorbance data for each monochromatic dye constituting a mixed dye generated according to a dye recipe for the target color; and
calibrating the dye recipe on the basis of absorbance data for the electronic color value and absorbance data for each of the monochromatic dyes.

14. The dye recipe calibration method of claim 13, wherein the calibrating of the dye recipe includes:
generating absorbance data for the mixed dye on the basis of the absorbance data for each of the monochromatic dyes;
performing a process of detecting a maximum absorbance wavelength value, which is defined as a wavelength value with the largest absorbance, from the absorbance data for the electronic color value, the monochromatic dyes, and the mixed dye;
determining a priority of each of the monochromatic dyes on the basis of maximum absorbance wavelength values for each of the monochromatic dyes and the electronic color value; and
calibrating a dye recipe for a first priority monochromatic dye on the basis of maximum absorbance wavelength values for the electronic color value and the mixed dye.

15. The dye recipe calibration method of claim 14, wherein, in the determining of the priority, it is determined that a monochromatic dye with a maximum absorbance wavelength value whose difference from the maximum absorbance wavelength value for the electronic color value is smallest is the first priority monochromatic dye.

16. The dye recipe calibration method of claim 14, wherein, in the calibrating of the dye recipe for the first priority monochromatic dye, when a difference between the maximum absorbance wavelength values for the electronic color value and the mixed dye is greater than or equal to a preset first reference value, the first priority monochromatic dye is changed to another monochromatic dye belonging to the same dye group.

17. The dye recipe calibration method of claim 14, wherein the calibrating of the dye recipe for the first priority monochromatic dye includes:
performing a process of detecting a maximum absorbance, which is defined as an absorbance at the maximum absorbance wavelength value, from the absorbance data for the electronic color value and the monochromatic dyes; and
calibrating a concentration of the first priority monochromatic dye to match the maximum absorbance for the electronic color value and the maximum absorbance for the mixed dye.

18. The dye recipe calibration method of claim 17, wherein, in the calibrating of the concentration of the first priority monochromatic dye, when the maximum absorbance for the electronic color value is greater than the maximum absorbance for the mixed dye, the processor increases the concentration of the first priority monochromatic dye, and when the maximum absorbance for the electronic color value is less than the maximum absorbance for the mixed dye, the processor decreases the concentration of the first priority monochromatic dye.

19. The dye recipe calibration method of claim 14, wherein:
the calibrating of the dye recipe further includes calibrating a dye recipe for a second priority monochromatic dye on the basis of the maximum absorbance wavelength value for the electronic color value and the maximum absorbance wavelength value for the mixed dye; and
the calibrating of the dye recipe for the second priority monochromatic dye includes:
setting a wavelength section with a preset size centered on the maximum absorbance wavelength value for the second priority monochromatic dye as a reference wavelength section;
calculating a first calculated value defined as an absolute value of a difference between an absorbance of the electronic color value and an absorbance of the mixed dye integrated over the reference wavelength section;
calculating a second calculated value defined as an absolute value of a difference between the absorbance of the electronic color value and the absorbance of the mixed dye integrated over the reference wavelength section; and
calibrating the dye recipe for the second priority monochromatic dye on the basis of the first and second calculated values.

20. The dye recipe calibration method of claim 19, wherein, in the calibrating of the dye recipe for the second priority monochromatic dye on the basis of the first and second calculated values, when a value obtained by subtracting the second calculated value from the first calculated value is greater than or equal to a preset second reference value, the second priority monochromatic dye is changed to another monochromatic dye belonging to the same dye group.
